(19) United States
(12) Patent Application Publication
(10) Pub. No.: US 2012/0003519 A1
(43) Pub. Date: Jan. 5, 2012

(54) LITHIUM ION BATTERY

(76) Inventor: Huijun GU, Dongguan (CN)

(21) Appl. No.: 13/234,166

(22) Filed: Sep. 16, 2011

Related U.S. Application Data
(63) Continuation of application No. PCT/CN2010/078524, filed on Nov. 8, 2010.

(30) Foreign Application Priority Data
Jun. 11, 2010 (CN) 201010197892.0

(51) Int. Cl. H01M 2/12; H01M 2/04; H01M 10/00

(52) U.S. Cl. 429/82

(57) ABSTRACT

A lithium ion battery including a lithium ion battery core, a cylindrical aluminum shell, a positive guide needle of the anode, a negative guide needle of the cathode, an end cover, a sealing band, and a girdling band. The lithium ion battery core is arranged within the cylindrical aluminum shell. The positive guide needle of the anode and the negative guide needle of the cathode are led out from the end cover. The lithium ion battery core is sealed in the cylindrical aluminum shell via the sealing band and the girdling band which are molded by rolling. The bottom plane of the cylindrical aluminum shell is provided with an explosion-proof impression. The lithium ion battery has high capacity, high power, and high voltage. The batters also has a simple structure, is convenient to use, and features high safety.

### CROSS-REFERENCE TO RELATED APPLICATIONS

This application is a continuation of International Patent Application No. PCT/CN2010/078524 with an international filing date of Nov. 8, 2010, designating the United States, now pending, and further claims priority benefits to Chinese Patent Application No. 201010197892.0 filed Jun. 11, 2010. The contents of all of the aforementioned applications, including any intervening amendments thereto, are incorporated herein by reference.

### BACKGROUND OF THE TECHNOLOGY

1. Field of the Invention

The invention relates to the field of lithium ion battery technology, and more particularly to a lithium ion battery.

2. Description of the Related Art

Conventional cylindrical lithium ion batteries generally use rigid packaging materials such as stainless steel. Since lithium ion batteries are likely to produce gas in the case of damage, overcharge, and high temperature, a gas outlet is commonly arranged at an anode head thereof to avoid explosion caused by delayed gas release. The anode of a conventional cylindrical lithium ion battery is usually a protruded head and the cathode thereof is a flat bottom. In use, cylindrical lithium ion batteries are often connected in series to provide high capacity and high power of voltage and current for electrical appliances. If they are connected in parallel, a dedicated battery box is required. Thus, it is troublesome and difficult to meet varied requirements under different occasions either in series or in parallel.

### SUMMARY OF THE INVENTION

In view of the above-described problems, it is one objective of the invention to provide a cylindrical lithium ion battery that has a rolling girdled and sealed structure, with anode and cathode lead-out along the same direction, and is easily used in series or in parallel under different occasions. The battery comprises a gas-release impression at the bottom thereof.

To achieve the above objective, in accordance with one embodiment of the invention, there provided is a lithium ion battery comprising a lithium ion battery core, a cylindrical aluminum shell, a positive guide needle of anode, a negative guide needle of cathode, an end cover, a sealing band, and a girdling band, wherein the lithium ion battery core is arranged within the cylindrical aluminum shell, the positive guide needle of anode and the negative guide needle of cathode are led out from the end cover, the lithium ion battery core is sealed in the cylindrical aluminum shell through the sealing band and the girdling band which are molded by rolling, and a bottom plane of the cylindrical aluminum shell is provided with an explosion-proof impression.

In a class of this embodiment, the positive guide needle of anode and the negative guide needle of cathode are led out in the same direction from the end cover and are respectively riveted to an anode ear and a cathode ear.

In a class of this embodiment, the end cover is a rubber plug.

In a class of this embodiment, the explosion-proof impression X-shaped or a Y-shaped.

Advantages of the invention are summarized below. The lithium ion battery has a simple structure, convenient use, and high safety. Since the lithium ion battery core is sealed in the cylindrical aluminum shell, and the positive guide needle of anode and negative guide needle of cathode are led out in the same direction from the end cover, the lithium ion batteries can be conveniently connected either in series or in parallel when used in different electrical appliances. The rolling girdled and sealed structure applied to the cylindrical aluminum shell makes it possible for high efficient production and reliable sealing quality. In addition, the explosion-proof impression arranged at the bottom of the aluminum shell can effectively release gas produced by the lithium ion battery under different occasions to avoid explosion caused by delayed gas release.

### DESCRIPTION OF THE DRAWINGS

FIG. 1 is a schematic diagram of a lithium ion battery in accordance with one embodiment of the invention;

FIG. 2 is a schematic diagram of guide needles riveted to an anode ear and a cathode ear in accordance with one embodiment of the invention;

FIG. 3 is a schematic diagram of an explosion-proof impression at the bottom of a cylindrical aluminum shell in accordance with one embodiment of the invention; and

FIG. 4 is another schematic diagram of an explosion-proof impression at the bottom of a cylindrical aluminum shell in accordance with one embodiment of the invention.

In the drawings, the following reference numbers are used: lithium ion battery core 1, cylindrical aluminum shell 2, end cover 3, positive guide needle of anode 4, negative guide needle of cathode 5, explosion-proof impression 6, sealing band 7, girdling band 8, rubber plug 9, anode ear 10, and cathode ear 11.

### DETAILED DESCRIPTION OF THE EMBODIMENTS

The invention is explained in further detail below with the aid of the examples and attached drawings.

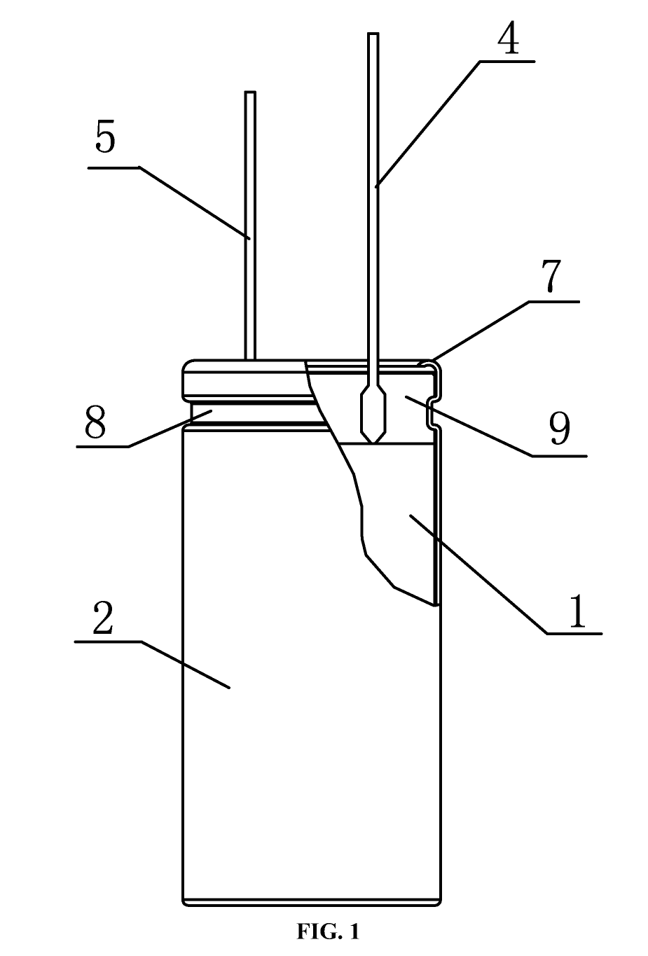

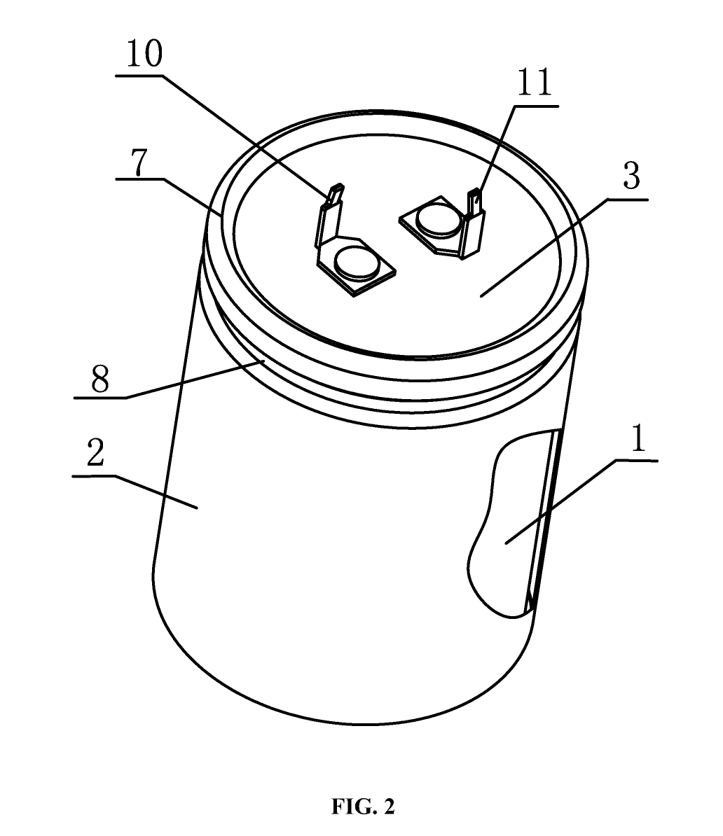

As shown in FIGS. 1 and 2, a lithium ion battery comprises a lithium ion battery core 1. The lithium ion battery core 1 is arranged within a cylindrical aluminum shell 2. A positive guide needle of anode 4 and a negative guide needle of cathode 5 are led out from an end cover 3. The lithium ion battery core 1 is sealed in the cylindrical aluminum shell 2 through a sealing band 7 and a girdling band 8 which are molded by rolling. The bottom plane of the cylindrical aluminum shell 2 is provided with an explosion-proof impression 6. The positive guide needle of anode 4 and the negative guide needle of cathode 5 are led out in the same direction from the end cover 3 and are respectively riveted to an anode ear 10 and a cathode ear 11. The top end of the cylindrical aluminum shell 2 is applied either with the end cover 3 or a rubber plug 9.

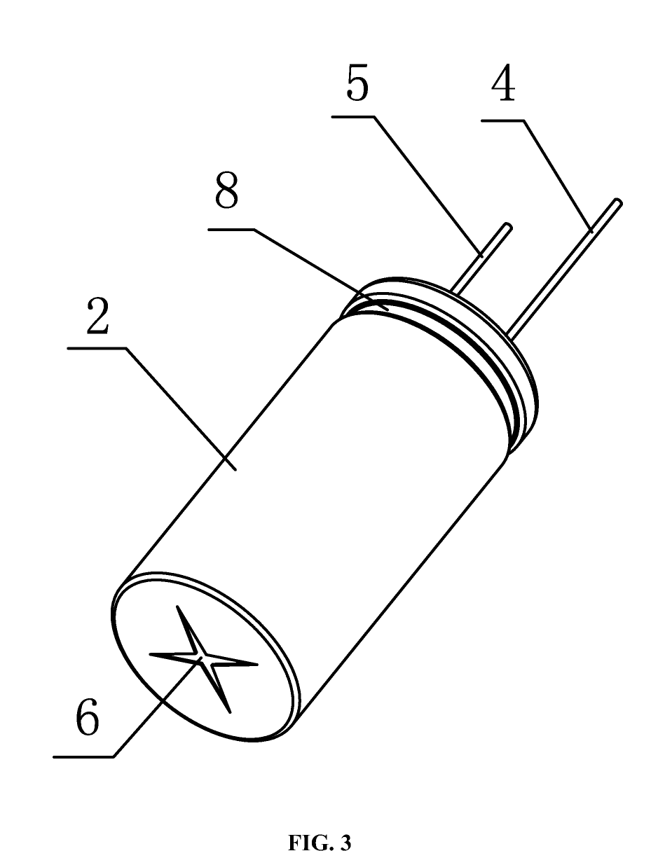

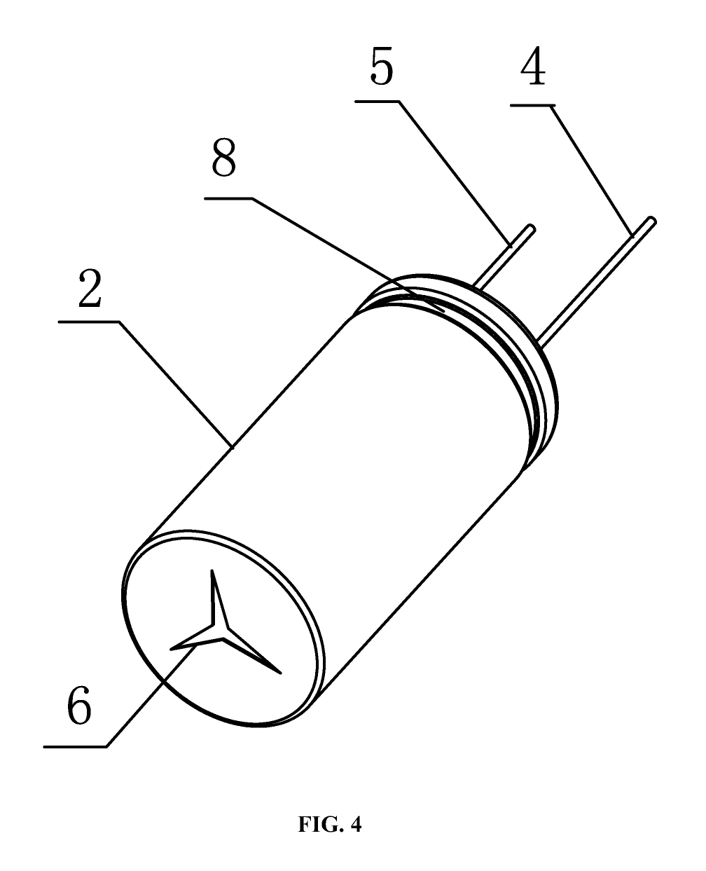

As shown in FIGS. 3 and 4, the explosion-proof impression at the bottom plane of the cylindrical aluminum shell 2 is either X-shaped or Y-shaped.

In accordance with the invention, the lithium ion battery core 1 is sealed in the cylindrical aluminum shell 2. The positive guide needle of anode 4 and negative guide needle of cathode 5 are led out in the same direction from the end cover 3 or the rubber plug 9. The sealing band 7 and the girdling band 8, molded using a rolling sealing device, are applied to the lithium ion battery with lead-out anode and cathode along same direction. The lithium ion battery of the invention has the advantages of simple structure, high efficient production, and reliable sealing quality.

The lithium ion battery of the invention is made by first putting the positive and negative guide needles 4, 5 of the already wound lithium ion battery core 1 through the end cover 3 or the rubber plug 9, or making the positive and negative guide needles 4, 5 riveted to the anode ear 10 and the cathode ear 11 through the end cover, then sealing the lithium ion battery core 1 having the end cover 3 or the rubber plug 9 in the cylindrical aluminum shell 2, and finally sealing the cylindrical aluminum shell 2 containing the lithium ion battery core 1 together with the end cover 3 or the rubber plug 9 by a rolling sealing device, and meanwhile forming the sealing band 7 and the girdling band 8 at the end of the cylindrical aluminum shell 2 to complete the whole production process of the lithium ion battery.

With respect to different electrical appliances, different connection methods can be adopted for the lithium ion battery. The positive and negative guide needles 4, 5 led out in the same direction from the end cover 3 or the rubber plug 9, or the riveted anode ear 10 and the cathode ear 11, all can be conveniently connected with an electrical appliance either in series or in parallel to provide the lithium ion battery with high capacity, high power, and high voltage for the electrical appliance.

The explosion-proof impression 6, either in an X shape or a Y shape or other shapes with the same purpose, is arranged at the bottom of the cylindrical aluminum shell 2. When the lithium ion battery produces gas due to damage, overcharge, or high temperature, such gas can be released from the gas outlet of the explosion-proof impression 6 in time to prevent the lithium ion battery from exploding, thereby improving the safety and reliability of the battery.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A lithium ion battery, comprising:
a) a lithium ion battery core;
b) a cylindrical aluminum shell;
c) a positive guide needle of anode;
d) a negative guide needle of cathode;
e) an end cover;
f) a sealing band; and
g) a girdling band;
wherein
the lithium ion battery core is arranged within the cylindrical aluminum shell;
the positive guide needle of anode and the negative guide needle of cathode are led out from the end cover;
the lithium ion battery core is sealed in the cylindrical aluminum shell through the sealing band and the girdling band which are molded by rolling; and
a bottom plane of the cylindrical aluminum shell is provided with an explosion-proof impression.

2. The lithium ion battery of claim 1, wherein the positive guide needle of anode and the negative guide needle of cathode are led out in the same direction from the end cover and are respectively riveted to an anode ear and a cathode ear.

3. The lithium ion battery of claim 1, wherein the end cover is a rubber plug.

4. The lithium ion battery of claim 2, wherein the end cover is a rubber plug.

5. The lithium ion battery of claim 1, wherein the explosion-proof impression X-shaped or a Y-shaped.
